(19) United States
(12) Patent Application Publication
(10) Pub. No.: US 2021/0110799 A1
(43) Pub. Date: Apr. 15, 2021

(54) HANDS-FREE COMPUTER ACCESSORY FOR OPTIMIZING MUSICAL INSTRUCTION

(71) Applicant: Elmore Pedal Company, LLC, Highland Park, IL (US)

(72) Inventors: James Andrew Levin, Highland Park, IL (US); Adithya Suresh Menon, Chicago, IL (US); Eric Schneider, Naples, FL (US)

(21) Appl. No.: 17/065,257

(22) Filed: Oct. 7, 2020

Related U.S. Application Data
(60) Provisional application No. 62/914,795, filed on Oct. 14, 2019.

(51) Int. Cl. G10G 7/00; G06F 3/0484

(52) U.S. Cl. CPC G10G 7/00; G06F 3/0484

(57) ABSTRACT

A portable hands-free computer accessory having a housing, a controller, and a first and second button separated by a surface area configured to accommodate a foot of a user. The controller is configured to detect a first set of two or more commands associated with a first set of one or more actuation types of the first button, each command from the first set of commands corresponding to a respective actuation type from the first set of actuation types, detect a second set of two or more commands associated with a second set of one or more actuation types of the second button, each command from the second set of playback commands corresponding to a respective different actuation type from the second set of actuation types, and, based on the first and second sets of commands, control playback of a video displayed on a computing device.

### CROSS REFERENCE TO RELATED APPLICATIONS

The present application claims the benefit to U.S. Provisional Patent Application No. 62/914,795 filed on Oct. 14, 2019, which is incorporated herein by reference in its entirety.

### FIELD

The present disclosure generally relates to a portable hands-free computer accessary for optimizing musical instruction.

### BACKGROUND

Existing mechanisms for musical instruction often involve the use of instructional videos and/or other types of audiovisual instruction, which can supplement or serve as an alternative to in-person music lessons. Particularly, a user attempting to learn an instrument such as guitar, bass, piano, violin, or mandolin might watch a video over the Internet, or use software, that is designed to help the user learn a particular song or musical technique. For example, the user can watch a video, either over the Internet or offline, where a musician breaks down how to play a guitar solo, and/or the user can access software online or offline that plays out an audio file (e.g., a MIDI track) of a song while enabling the user to simultaneously view corresponding tablature or other musical notation for the song.

There are problems with existing mechanisms and devices for musical instruction. For example, many existing mechanisms and devices require a user to remove his/her hands from their instrument to operate a mouse, keyboard, or other device to control playback (e.g., pause, play, fast forward, and rewind) a portion of the audiovisual instruction, which is inefficient for learning and can negatively impact user experience. The act of taking ones hand off the instrument reduces muscle memory learning and can distract the user. As a result, the user is more likely to quit the musical instruction.

Consequently, there is a need for more user-friendly, more ergonomic, and more versatile hand-free device for allowing a user to keep their hands on a musical instrument.

### SUMMARY

What is provided is a portable hands-free computer accessory. The accessory may include a housing comprising a base portion and a top portion, the top portion having a top surface sloping downward from a back wall of the base portion to a front wall of the base portion. The accessory may also include a controller disposed within the housing. The accessory may also include a first button operably connected to the controller and projecting out of the top portion. The accessory may also include a second button operably connected to the controller and projecting out of the top portion, wherein the first button and second button are separated by a surface area configured to accommodate a width of a foot of a user. The controller may be configured to engage in communication with a computing device, and, while engaged in communication with the computing device: detect a first set of two or more playback commands associated with a first set of one or more actuation types of the first button, each playback command from the first set of two or more playback commands corresponding to a respective different actuation type from the first set of one or more actuation types, detect a second set of two or more playback commands associated with a second set of one or more actuation types of the second button, each playback command from the second set of two or more playback commands corresponding to a respective different actuation type from the second set of one or more actuation types, and, based on the first set of two or more playback commands on the second set of two or more playback commands, control playback of a video being displayed on the computing device.

The features, functions, and advantages may be achieved independently in various embodiments of the present disclosure or may be combined in yet other embodiments in which further details may be seen with reference to the following description and drawings.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 illustrates a schematic perspective view of a hands-free computer accessory for optimizing musical instruction according to an embodiment of the disclosure;

FIG. 2 illustrates a schematic front view of the hands-free computer accessory illustrated in FIG. 1;

FIG. 3 illustrates a schematic back view of the hands-free computer accessory illustrated in FIGS. 1 and 2;

FIG. 4 illustrates a schematic side perspective view of the hands-free computer accessory illustrated in FIGS. 1-3;

FIG. 5 illustrates a schematic top perspective view of the hands-free computer accessory illustrated in FIGS. 1-4;

FIG. 6 illustrates a block diagram depicting communication between the hands-free computer accessory illustrated in FIGS. 1-5 and an exemplary computing device; and

FIG. 7 illustrates a diagram of an exemplary printed circuit board (PCB) that can be included in the hands-free computer accessory illustrated in FIGS. 1-6.

### DETAILED DESCRIPTION

It is to be understood that the present disclosure may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

The present disclosure relates to a hands-free computer accessory for optimizing musical instruction, particularly in the context of online or offline videos (e.g., a YouTube® video where a professional musician provides teaches instrument technique or how to play a specific song), software that plays musical notation (e.g., tablature) along with a corresponding audio track, and/or other methods of audiovisual instruction. For brevity, these and other audiovisual instructions may be referred to collectively herein as “videos.”

Furthermore, although the disclosed hands-free computer accessory will be primarily described herein for use in the context of videos related to musical instruction, it should be understood that the accessory could be used in many other contexts, such as a user controlling playback of an instructional video for cooking a meal while attempting to cook the meal.

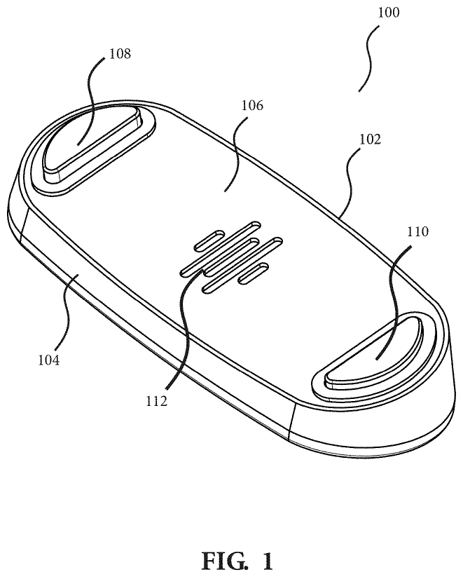

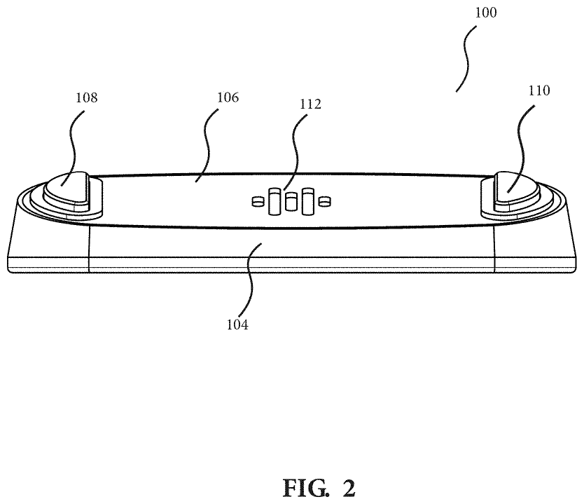

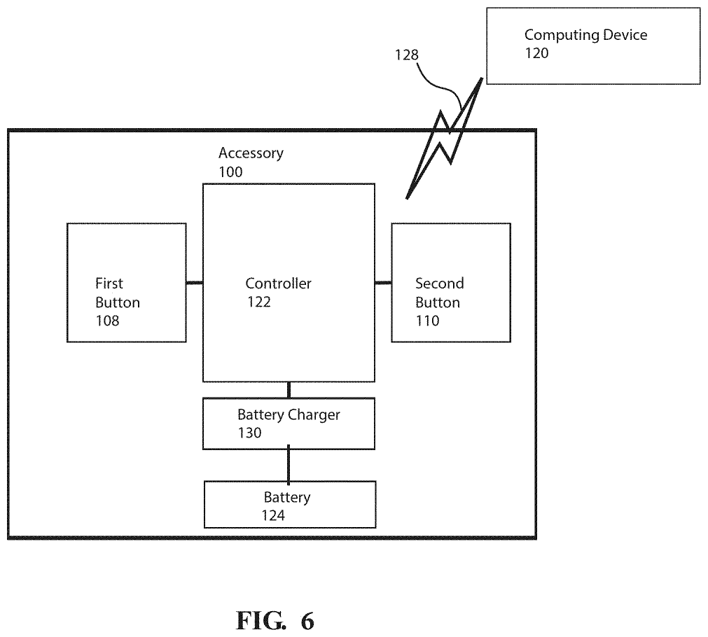

FIGS. 1-5 illustrate views of a hands-free computer accessory 100 for optimizing musical instruction according to an embodiment of the disclosure. According to this embodiment, the accessory 100 includes a housing 102 having a base portion 104 and a top portion 106. Further, the accessory 100 includes a first button 108, a second button 110, and an indicator 112. Each of the buttons 108, 110 can be operably connected to a controller 122 positioned within the housing 102, as best shown in FIG. 6 and described below.

The housing 102 may be made of metal, plastic, or another material. The base portion 104 and the top portion 106 may be made of the same material or can be made of different materials. The base portion 104 and the top portion 106 can be separate components that are attached together to form the housing 102. Alternatively, the housing 102 can be assembled in a different manner. In some cases, the housing 102 and/or one or more other components of the accessory 100 (e.g., buttons 108, 110) can be 3D printed or manufactured in other ways.

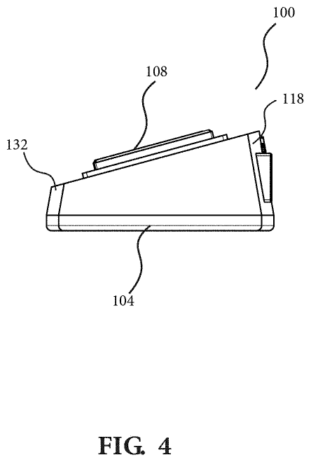

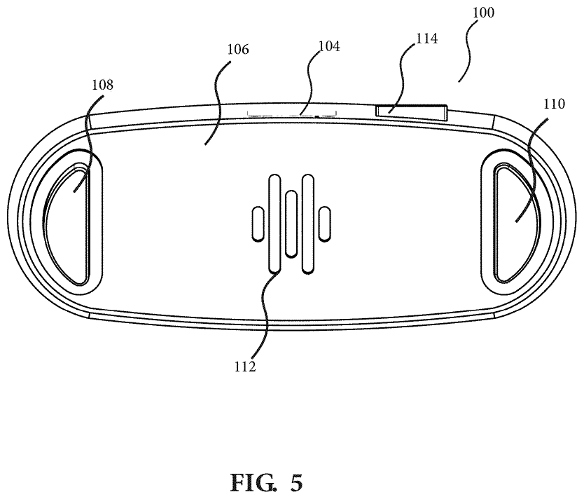

The housing 102 can be designed to maximize user experience. As best shown in FIGS. 4 and 5 and as a non-limiting example, the top portion 106 can be designed to slope downward from a back wall 118 of the base portion 104 of the accessory 100 to a front wall 132 of the base portion 104 of the accessory 100, thereby providing an angled surface on which a user can comfortably rest their foot. As another example, the top portion 106 can include a wide surface area (e.g., within approximately 8-14 square inches) between holes or other areas at which the buttons 108, 110 are mounted. This gives space for the user to rest their foot, while retaining reachability of the buttons 108, 110 (i.e., not requiring the user's foot to travel a far distance to reach the buttons 108, 110), which increases ease of use and reduces user fatigue, particularly over long periods of use of the accessory 100.

As yet another example, at least part of the housing 102 can be made of lightweight material (e.g., plastic), and the housing 102 can have dimensions selected to facilitate portability (e.g., small enough to fit in a compartment of a backpack or an instrument case). For example, the housing 102 can be approximately 6-8 inches in length, 2.5-3.5 inches in width, and 1-2 inches in max height. Other examples are possible as well.

The first button 108 and/or the second button 110 can take the form of tactile push-button momentary switches that are operably connected to the controller 122 and that enable the user to control video playback. The buttons 108, 110 can have a low profile and can be mounted to the controller 122 (e.g., mounted to a PCB), which can reduce the overall form factor of the accessory 100. Further, the buttons 108, 110 can be configured such that the travel distance between the open position and the closed position of the switches is minimized. The low profile and short travel distance can help reduce response time and increase the accuracy of video control operation. For example, having a low profile and short travel distance for the buttons 108, 110 can enable the user to more quickly pause and rewind a video. For example, the profile of each of the buttons 108, 110 relative to the top surface of the top portion 106 can be selected from a range of approximately 0.1 inches to approximately 0.3 inches (e.g., 0.141 inches). Further, the travel distance for each button can be approximately 0.005 inches to approximately 0.02 inches (e.g., 0.012 inches, or 0.3 millimeters) with tactile feedback when depressed, and the operating force for operating the buttons 108, 110 can be approximately 2.5 Newtons to approximately 2.6 Newtons. Other examples are possible as well.

Still further, the buttons 108, 110 can have a larger surface area, which can make the buttons 108, 110 easier to press, and can be configured such that the user can actuate a particular button with contact at nearly any location on the button's surface area, as opposed to requiring a user to press the button at a specific location, which can further improve ease of use. For example, the buttons 108, 110 can each have a surface area selected from a range of 0.4 square inches to 0.7 square inches (e.g., 0.545 square inches).

Although embodiments herein are primarily described as having two buttons, alternative embodiments can include more or less buttons, each of which can be configured for use in performing one or more of the button operations described herein.

In line with the discussion above, the accessory 100 can implement hardware debouncing and/or software debouncing to improve signal clarity—namely, so that the controller 122 can determine that, when a particular button is pushed, a single input has been received and responsively act on the single input as opposed to determining/acting on multiple inputs. For example, hardware debouncing can be accomplished with a pull up resistor on the controller 122, in combination with one or more other resistors and/or capacitors. Software debouncing can be accomplished with a predetermined time delay (e.g., twenty milliseconds).

As best seen in FIGS. 1 and 5, the indicator 112 can take the form of a light-emitting diode (LED) or other visual indicator operably connected to the controller 122. The controller 122 can be configured to cause the indicator 112 to visually represent different conditions associated with the accessory 100, such as by having a particular color, by blinking in a particular pattern. For example, the indicator 112 might have a first color when a battery 124 (as best shown in FIG. 6 housed within the accessory 100 is charged at or above a particular threshold and might have a second, different color when the charge of the battery 124 falls below the particular threshold.

Additionally or alternatively, the indicator 112 can have one color when the accessory 100 is on, but not connected to a computing device, and another color when the accessory 100 is connected to the computing device. Additionally or alternatively, the indicator 112 can blink, increase brightness, or change colors when an input is successfully received. Other examples of indicator functionality are possible as well.

In some embodiments, additionally or alternatively to having the indicator 112, the accessory 100 can include a display device (e.g., a touch screen or other screen) configured to provide a graphical user interface (GUI) that can display information associated with the accessory 100, such as in the form of text or graphics. For example, if the accessory 100 is connected to a metronome, the display device can display a number of beats per minute to which the metronome is set. In other examples, the display device can display indicators of successful connections to other devices, low battery, charged battery, and/or other relevant information.

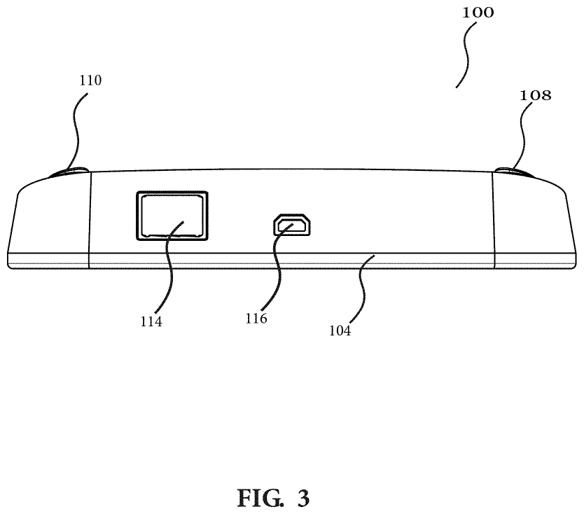

As best seen in FIG. 3, the base portion 104 of the accessory 100 includes a power switch 114 and an input/output port 116. The power switch 114 can be operably coupled to the controller 122 and can toggle the accessory 100 between a power off state and a power on state. The input/output port 116 can take the form of a USB port (e.g., a micro-USB port) configured to receive a cable for connecting the accessory 100 to a computing device such as a laptop, tablet, or other computing device. In some embodiments, the input/output port 116 can also function as a charge port for connecting to an external power source and charging the battery of the accessory 100. The external power source can be the computing device (e.g., so the accessory 100 can charge its battery or otherwise be powered by the computing device) or a wall outlet, for example.

In some embodiments, the accessory 100 can be water-resistant, dust/debris-resistant, and/or shock resistant. For example, the accessory 100 can include water-resistant seals and hydrophobic nano-coating.

FIG. 6 illustrates a block diagram depicting communication between the hands-free computer accessory 100 illustrated in FIGS. 1-5 and a computing device 120 according to an embodiment of the disclosure. In addition to the buttons 108, 110, the accessory 100 includes the controller 122, the battery 124 (e.g., a rechargeable battery), and a battery charger 130 configured to charge the battery 124. Further, also shown is a communication link 128 between the accessory 100 and the computing device 120.

The computing device 120 can take various forms, such as a personal computer, laptop, tablet computer, smartphone, or video game console. Other types of computing devices are possible as well. The accessory 100 can be configured to be compatible with a variety of computing devices and operating systems running thereon. Non-limiting examples of some of the operating systems on the computing device 120 that the accessory 100 may be compatible with include Android®, iOS®, Windows®, Linux®, and macOS®.

The controller 122 may be a microcontroller and may be implemented using hardware (e.g., a PCB), software, and/or firmware. For example, the controller 122 can include one or more processors and a non-transitory computer readable medium (e.g., volatile and/or non-volatile memory) that stores program code or other executable instructions. The instructions, when executed by the one or more processors, may cause the controller 122 to perform various operations, including but not limited to the various playback control operations described herein.

The battery 124 can be a non-rechargeable or rechargeable battery. Further, the accessory 100 can be engaged in wired communication with the computing device 120 and in use while the computing device 120 is charging the battery 124.

The communication link 128 can be a wired connection (e.g., micro-USB cable) and/or a wireless connection (e.g., Bluetooth® or Wi-Fi) over which the accessory 100 and the computing device 120 can transmit signals (e.g., radio frequency signals) to each other.

In example operation of the accessory 100, the user can turn on the accessory 100 and connect the accessory 100 to the computing device 120 over a wireless or wired connection. The user can also open a video on the computing device 120, such as a YouTube® or Vimeo® video in an Internet browser, tablature with corresponding MIDI audio, or a video stored locally and viewable via media player software installed on the computing device 120.

Once the communication link 128 is established, the controller 122 can receive signals based on actuation of one or both of the buttons 108, 110 and transmit signals to the computing device 120 that control playback of the video. To facilitate this, in some embodiments, the computing device 120 might be configured to interpret the signals received from the accessory 100 as playback control commands, and/or a software application running on the computing device 120 (e.g., a software application designed for specific use with the accessory 100, as will be described in more detail later herein) can be configured to translate the signals to be recognizable by the computing device 120 (e.g., to translate the signals to executable media control commands on videos on the software application or other application running on the computing device 120 such as a web browser or media player). In some embodiments, such a software application can be configured to utilize existing application programming interfaces (APIs) to display videos in the software application (e.g., utilizing a YouTube® API to display YouTube® videos in the software application).

In line with the discussion above, the controller 122 can be configured to enable each of the buttons 108, 110 to be used for one or more of the following operations for controlling video playback: (i) pausing the video, (ii) initiating/resuming playback of the video, (iii) rewinding the video, (iv) fast forwarding the video, (v) creating a loop of a section of the video having a predetermined duration (e.g., ten seconds) to be automatically played on repeat, (vi) ending the created loop, (vii) slowing down the video, (viii) speeding up the video, and/or (ix) jumping a predetermined duration to another time in the video (e.g., ten seconds) behind or ahead of the current time in the video, among other possibilities. These operations can also be referred to as “events” or “commands” that are triggered in response to actuation of the buttons 108, 110.

The controller 122 can be configured to recognize different types of actuation of each of the buttons 108, 110 and responsively cause different playback operations to occur. Example actuation types can include a “double click” (e.g., two sequential presses in quick succession within a predetermined threshold duration, such as two presses within 0.5 seconds or less), a “press-and-hold” (e.g., holding the button down for a predetermined duration of time), and a single press (e.g., a press and release without hold or double click). The controller 122 can be configured to recognize other actuation types as respective events as well. Furthermore, the predetermined durations of time used by the controller 122 to distinguish types of actuation can be adjusted by changing program code or perhaps by using a software application designed for use with the accessory 100.

The controller 122 can be configured to recognize certain mappings of button actuations to events/operations. In a first example, the controller 122 can be configured such that (i) a single press of the first button 108 can play the video (e.g., an initial play, or resuming play after the video had been paused), pause the video, and resume a default speed of the video (if the video had been slowed down), (ii) a press-and-hold of the first button 108 (e.g., for at least two seconds or another predefined duration of time) can create a playback loop having a predetermined duration and can end a previously-created playback loop, and (iii) a double click of the first button 108 can slow down the video, such as by reducing the speed of the video by a predetermined amount (e.g., half speed, three-quarters speed, etc.). Additionally, in this first example, the controller can be configured such that a single press of the second button 110 once can fast forward the video (e.g., in five second increments—that is, five seconds per individual press) and a press-and-hold of the second button 110 (e.g., for at least two seconds or another predefined duration of time) can rewind the video.

In one of many possible alternative examples, the controller can be configured such that the first button 108 operates as described in the previous example, but the controller can be configured such that a single press of the second button 110 can rewind the video (e.g., in five second increments—that is, five seconds per individual press) and a press-and-hold of the second button 110 (e.g., for at least two seconds or another predefined duration of time) can fast forward the video.

Other example combinations of button functionality are possible as well. Further, the user can reconfigure button-to-event mappings by changing program code and/or by using a software application designed for use with the accessory 100. Thus, the user can advantageously tailor the accessory 100 to best suit their use. For example, both of the buttons 108, 110 may be simultaneously pressed to create a new command for a user. A user may also configure the actuation types, amounts, and sequences of the buttons 108, 110 to define the commands based on the user's preferences. As a result, the controller 122 can be configured to recognize actuation types and commands configured by a particular user of the accessory 100.

In some embodiments of the accessory 100, the controller can be configured to set or adjust the duration for created loops based on how long the user holds down the button (e.g., whichever of the buttons 108, 110 is designated for loop functionality). Further, the duration associated with the controller detecting a press-and-hold for creating or ending playback of a loop can be a different duration than the duration associated with the controller setting or adjusting the duration of created loops. For example, a press-and-hold of four seconds or less can be associated with creating or ending a loop, whereas a press-and-hold of greater than four seconds can be associated with setting or adjusting loop duration. As such, in this example, the controller can be configured such that, in response to detecting that the user has held down the first button 108 for eight seconds, the controller will set itself to thereafter recognize that a press-and-hold of the first button 108 that is four seconds or less will create a loop of eight seconds in duration. Other examples are possible as well.

By having two multi-function buttons 108, 110, the accessory 100 is less complex and more streamlined than existing hands-free mechanisms. For example, some existing hands-free playback control devices include four or more different buttons, each being configured for performing one particular function (e.g., one button for pausing, one button for creating a loop, etc.). This can be problematic in various ways. For example, having numerous buttons can crowd the device and leave no space on which the user can rest their foot, thus requiring the user to move their foot greater distances and/or pay closer attention to which button they are hitting, thereby increasing user fatigue and reducing ease of use. By contrast, the accessory 100 provides a space for the user to rest their foot, while also placing the user's foot in close proximity to two simplified buttons capable of multiple functions, thereby reducing the distance the user needs to move their foot to press the buttons. In some embodiments, such as those where the housing 102 has a low profile (e.g., a minimum height of 0.75 inches), the close proximity and spacing of the buttons 108, 110 can facilitate pivoting of the user's foot between the buttons 108, 110, as opposed to the user having to lift their heel off the ground, which can even further reduce user fatigue and improve user experience. Other advantages are possible as well.

The accessory 100 can include other components not explicitly shown in FIGS. 1-6, such as a compartment for connecting one or more non-rechargeable batteries, one or more speakers, a microphone (e.g., for voice commands or for a user to provide other audible input, such as singing), one or more input/output ports (e.g., Universal Serial Bus (USB) ports, such as USB-C ports) configured to connect the accessory 100 to other devices (e.g., an external speaker, metronome, tuner, camera, or other device separate from the accessory 100), a charge port (e.g., a USB port or another type of port configured to receive a charging cable for connecting the accessory 100 to an external power source and charge a battery of the accessory 100), and/or one or more communication interfaces (e.g., modules) configured to engage in wireless radio frequency communication with other devices, such as Bluetooth® communication or another wireless technology standard. Any one or more of these or other components can be disposed within or connected to the housing 102.

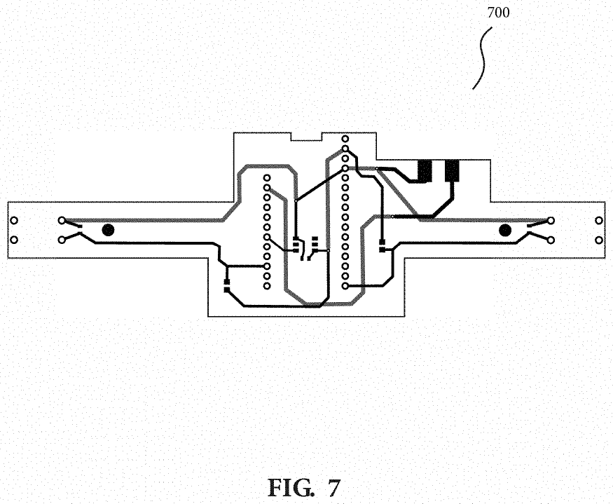

FIG. 7 is a diagram of a printed circuit board (PCB) 700 that can be included in the accessory 100 illustrated in FIGS. 1-6. It should be understood that the PCB 700 of the accessory 100 shown in FIG. 7 is a representative example, and that the PCB of the accessory 100 may take other forms in alternative embodiments.

In some implementations, as discussed above, a software application can be configured for use with the accessory 100, such as a proprietary software application associated with a developer/designer of the accessory 100 or a third-party software application. Such an application can be compatible for use with various operating systems, web browsers, and computing devices, such as the computing device 120.

In some examples, the software application can enable the user to remap buttons and events as discussed above, change time durations associated with button activation (e.g., how long a button must be held down to register as a push-and-hold trigger), and/or choose/adjust the duration for created loops to have (e.g., 20 seconds, 10 seconds, etc.), among other possibilities.

In some examples, the software application can provide users with curated content and user-generated lessons from musicians, students, and professional instructions, which can take the form of videos that are controllable using the accessory 100. The software application can be configured to filter such videos based on user-selected or default criteria, such as videos posted by instructors that are within a predetermined distance of the user's geolocation.

In some examples, the software application can provide an exclusive forum where users can share information, videos, etc.

In some examples, the software application can be used for providing exclusive backing audio and/or visual tracks designed for users of varying experience levels.

In some examples, the software application can host an online marketplace for buying, selling, trading, etc. of musical instruments, digital music backing tracks for learning, and/or other physical or digital items.

In some examples, the software application can facilitate coordination of remote video and/or audio lessons between individuals. For example, the software application may allow a user to readily access third-party content, such as musical tablature and other audiovisual instruction.

In some examples, the software application can include a recording functionality that uses a microphone on the computing device on which the software application is installed to allow the user to record themselves playing an instrument—either along with the video or with no video accompaniment. The software application can also be configured to support playback of the user's recorded video, either through a speaker of the computing device on which the software application is installed, a speaker installed as part of the accessory 100 itself, or some other external speaker.

In some examples, the software application can include gamification functions that enable users to compete, be ranked against each other, earn achievements, and share their progress, among some possibilities.

In some examples, the software application can support paid content hosting and geo-location.

In some examples, the software application may provide automated feedback to the user of the accessory 100 to help the user get the notes correct.

In some examples, the software application may allow for computation and display of user analytics, such as the time of the content watched, the type/genre of the content watch. This data and information may help with, among other things, determining how long it takes users of the accessory 100 to learn certain skill, the types of content/songs that other users of the accessory 100 are listening to, and the most popular functions.

In some examples, the software application can be configured to integrate with other software applications installed on the same computing device, such as YouTube®. Along similar lines, the software application and/or or the controller 122 can be configured to identify different websites and media players and responsively emulate keyboard shortcuts for those websites/players, thus facilitating versatility of the accessory 100 and efficient use across multiple types of websites/players with minimal to no loss in functionality. For example, a user can have two different media players open in two different Internet browser windows and the software application and/or the controller 122 can determine which one is currently being used to view a video and responsively configure itself to emulate keyboard strokes/shortcuts that are typically recognized by the currently-used media player. Thus, the user can switch back and forth without having to manually indicate to the software application or the controller 122 that the switching is occurring.

In some examples, the software application can be configured with a metronome function and/or an instrument tuner to enhance a user's experience of using the accessory 100 when watching videos or other types of audiovisual instruction.

By the term “substantially,” “approximately,” or “about” used herein, it is meant that the recited characteristic, parameter, value, or geometric planarity need not be achieved exactly, but that deviations or variations, including for example, tolerances, measurement error, measurement accuracy limitations and other factors known to skill in the art, may occur in amounts that do not preclude the effect the characteristic was intended to provide.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present disclosure has been described to represent what is considered to represent the preferred embodiments. However, it should be noted that this disclosure can be practiced in other ways than those specifically illustrated and described without departing from the spirit or scope of this disclosure.

What is claimed is:

1. A portable hands-free computer accessory comprising:
a housing comprising a base portion and a top portion, the top portion having a top surface sloping downward from a back wall of the base portion to a front wall of the base portion;
a controller disposed within the housing;
a first button operably connected to the controller and projecting out of the top portion; and
a second button operably connected to the controller and projecting out of the top portion, wherein the first button and the second button are separated by a surface area configured to accommodate a width of a foot of a user,
wherein the controller is configured to engage in communication with a computing device, and, while engaged in communication with the computing device, the controller is configured to:
detect a first set of two or more playback commands associated with a first set of one or more actuation types of the first button, each playback command from the first set of two or more playback commands corresponding to a respective different actuation type from the first set of one or more actuation types,
detect a second set of two or more playback commands associated with a second set of one or more actuation types of the second button, each playback command from the second set of two or more playback commands corresponding to a respective different actuation type from the second set of one or more actuation types, and
control playback of a video being displayed on the computing device based on the first set of two or more playback commands and the second set of two or more playback commands.

2. The portable hands-free computer accessory of claim 1, wherein the first set of two or more playback commands comprises two or more of (i) pausing the video, (ii) playing the video, (iii) creating a playback loop of a predetermined loop duration, (iv) ending the playback loop, or (v) decreasing a playback speed of the video; and
wherein the second set of two or more playback commands comprises two or more of (i) fast forwarding the video in predetermined increments or (ii) rewinding the video in predetermined increments.

3. The portable hands-free computer accessory of claim 2, wherein the first set of one or more actuation types comprises one or more of (i) a single press of the first button, (ii) a double click of the first button within a predetermined threshold duration, or (iii) a press and hold of the first button for a predetermined hold duration; and
wherein the second set of one or more actuation types comprises one or more of (i) a single press of the second button, (ii) a double click of the second button within a predetermined threshold duration, or (iii) a press and hold of the second button for a predetermined hold duration.

4. The portable hands-free computer accessory of claim 1,
wherein the first button has a first profile relative to the top surface, the first profile having a first value selected from a range of 0.1 inches to 0.3 inches, and
wherein the second button has a second profile relative to the top surface, the second profile having a second value selected from a range of 0.1 inches to 0.3 inches.

5. The portable hands-free computer accessory of claim 1, wherein the first button has a first top surface configured for contact with a foot of a user, the first top surface having a first surface area selected from a range of 0.4 square inches to 0.7 square inches, and
wherein the second button has a second top surface configured for contact with a foot of a user, the second top surface having a second surface area selected from a range of 0.4 square inches to 0.7 square inches.

6. The portable hands-free computer accessory of claim 1, wherein a first distance over which the first button is movable during actuation has a first value selected from a range of 0.005 inches to 0.02 inches, and
wherein a second distance over which the second button is movable during actuation has a second value selected from a range of 0.005 inches to 0.02 inches.

7. The portable hands-free computer accessory of claim 1, wherein the surface area configured to accommodate the width of the foot of the user has a value selected from a range of 8 square inches to 14 square inches.

8. The portable hands-free computer accessory of claim 1, further comprising a battery and a battery charger disposed within the housing.

9. The portable hands-free computer accessory of claim 1, wherein the controller is in communication with the computing device via Bluetooth® or Wi-Fi.

10. The portable hands-free computer accessory of claim 1, wherein the base portion includes a power switch operably coupled to the controller and an input/output port.

11. The portable hands-free computer accessory of claim 10, wherein the input/output port is a USB port configured to receive a cable for connecting the accessory to the computing device.

12. The portable hands-free computer accessory of claim 1, wherein the controller is a microcontroller comprising a printed circuit board (PCB).

13. The portable hands-free computer accessory of claim 1 configured for use with a software application, wherein the software application is compatible for use with the computing device.
